(19) United States
(12) Patent Application Publication
(10) Pub. No.: US 2026/0251815 A1
(43) Pub. Date: Aug. 27, 2026

(54) MEASUREMENT DEVICE, MEASUREMENT METHOD, AND MANUFACTURING METHOD FOR MEASUREMENT DEVICES

(71) Applicant: SUMITOMO ELECTRIC INDUSTRIES, LTD., Osaka (JP)

(72) Inventors: Masashi OIKAWA, Osaka (JP); Rei KASAHARA, Osaka (JP); Yuka KISHIMOTO, Osaka (JP); Yoshiyuki MATSUBARA, Osaka (JP); Daisuke KUBODUKA, TOKYO (JP); Satoshi TANAKA, TOKYO (JP); Kazumasa OKUBO, Tokyo (JP); Michio IMAI, Tokyo (JP); Naoki SOGABE, Tokyo (JP)

(21) Appl. No.: 19/548,146

(22) Filed: Feb. 24, 2026

(30) Foreign Application Priority Data
Feb. 26, 2025 (JP) 2025-029004

(51) Int. Cl. G01V 8/24

(52) U.S. Cl. CPC G01V 8/24

(57) ABSTRACT

A measurement device includes: a measurement part including an optical fiber arrangement part having a planar shape. The measurement part includes: an optical fiber arranged in the optical fiber arrangement part; and a longitudinal protective material. At least a part of the optical fiber is arranged along a longitudinal direction of the protective material, and a part of the surface of the optical fiber is covered with the protective material.

### CROSS-REFERENCE TO RELATED APPLICATION

The present application claims priority under 35 U.S.C. § 119 to Japanese Patent Application No. 2025-029004, filed on Feb. 26, 2025, the contents of which are incorporated herein by reference in their entireties.

### TECHNICAL FIELD

The present disclosure relates to a measurement device, a measurement method, and a manufacturing method for measurement devices.

### BACKGROUND

Japanese Patent Application Laid-Open Publication No. 2005-181176 discloses an inclination measurement device including: a first fixed base fixed to a ground surface or a structure surface serving as a measurement point; an inclination sensor having one end rotatably supported by the first fixed base; a detection rod attached to the other end of the inclination sensor; and a second fixed base supporting a slide sleeve in which the other end of the detection rod is slidably housed, wherein the inclination sensor is configured to detect the inclination of the detection rod in the form of an angle.

### SUMMARY

A measurement device with regard to the present disclosure includes a measurement part including an optical fiber arranged in a planar shape, wherein the measurement part includes: an optical fiber arranged in the optical fiber arrangement part; and a longitudinal protective material for the optical fiber, wherein at least a part of the optical fiber is arranged along the longitudinal direction of the protective material and a part of a surface of the optical fiber is covered with the protective material.

### BRIEF DESCRIPTION OF THE DRAWINGS

FIG. 1 is an oblique view of one embodiment of the present disclosure with regard to a measurement device installed on a slope.

FIG. 2 is a schematic diagram of another example of optical fiber arrangement when an optical fiber arrangement part is viewed in the direction of a block arrow A in FIG. 1.

FIG. 3 is an explanatory diagram of an optical fiber when the optical fiber has deviated sections longitudinally arranged at certain intervals.

FIG. 4A is a schematic cross-sectional diagram of an optical fiber embedded in a protective material.

FIG. 4B is a schematic cross-sectional diagram of an optical fiber embedded in a protective material.

FIG. 4C is a schematic cross-sectional diagram of an optical fiber embedded in a protective material.

FIG. 5A is an explanatory diagram of a member to arrange and secure the optical fibers in the direction of the block arrow A in FIG. 1.

FIG. 5B is an explanatory diagram of a member to arrange and secure the optical fibers in the direction of the block arrow A in FIG. 1.

FIG. 6 is a schematic cross-sectional diagram taken along the line B-B in FIG. 1 when the measurement objective has a concrete structure.

### DETAILED DESCRIPTION

As disclosed in Japanese Patent Application Laid-Open Publication No. 2005-181176, measurement devices for measuring the state of ground, such as inclined ground and the like, and detecting occurrence of a landslide and the like have been used so far.

However, in many cases, conventional measurement devices can only perform local measurements, and installation of a plurality of measurement devices and the like have been necessary in order to know the state of ground, such as inclined ground and the like. Therefore, it has been impossible to perform wide area measurements of slopes and the like.

It is, therefore, an object of the present disclosure to provide a measurement device capable of measuring one or more selected from strain, temperature, or vibration over a wide range.

According to the present disclosure, it is possible to provide a measurement device capable of measuring one or more selected from strain, temperature, or vibration over a wide range.

Embodiments will be described below.

First, embodiments of the present disclosure will be described below. Hereinafter, the same or corresponding elements will be denoted by reference numerals without repeating the same descriptions.
(1) A measurement device with regard to one embodiment of the present disclosure includes a measurement part including an optical fiber arranged in a planar shape, wherein the measurement part includes: an optical fiber arranged in the optical fiber arrangement part; and a longitudinal protective material, wherein at least a part of the optical fiber is arranged along the longitudinal direction of the protective material and a part of a surface of the optical fiber is covered with the protective material.

Since the measurement device with regard to one embodiment of the present disclosure includes a measurement part including an optical fiber arranged in a planar shape, measurements can be performed with the optical fiber arrangement part installed in, for example, a slope and the like. Measurement data including one or more selected from strain, temperature, or vibration are available from the optical fiber arranged in the optical fiber arrangement part. Therefore, the measurement device according to one embodiment of the present disclosure can obtain one or more measurement data selected from strain, temperature, or vibration over the entirety of the optical fiber arrangement part in which the optical fiber is arranged. Hereinafter, one or more selected from strain, temperature, or vibration will be referred to as “strain and the like”.

By providing the measurement part with the protective material, arranging at least a part of the optical fiber along the longitudinal direction of the protective material, and covering a art of the surface of the optical fiber with the protective material, it is possible to prevent the optical fiber from fracture and the like.
(2) In the above (1), the optical fiber may have a plurality of deviated sections in the optical fiber arrangement part.

By arranging the optical fiber in the optical fiber arrangement part to have the plurality of deviated sections, it is possible to arrange one optical fiber in a planar shape. Therefore, strain and the like can be measured over a wide range by one optical fiber, and the number of scattered light measurement devices required for the measurement can be reduced.
(3) In the above (1) or (2), the measurement part may include a plurality of optical fibers, each of which is the optical fiber, and at least some of the plurality of optical fibers may be arranged to intersect each other in the plane view.

By providing the measurement part with the plurality of optical fibers, and arranging at least some of the plurality of optical fibers to intersect each other in the optical fiber arrangement part, it is possible to arrange the optical fibers to form a plane, which makes it possible to measure strain and the like over the entirety of the optical fiber arrangement part without omission.
(4) In any of the above (1) to (3), the protective material may include a stranded wire obtained by twisting element wires composed of metal, and the optical fiber may be arranged in a helical groove of the stranded wire.

When the protective material is a stranded wire, the protective material can be easily deviated. Therefore, the protective material in which the optical fiber is embedded can be easily deformed to conform to the shape of the optical fiber arrangement part, which makes it easy to lay the optical fiber throughout the optical fiber arrangement part.

In addition, by arranging the optical fiber in a helical groove of the stranded wire serving as the protective material, which is obtained by twisting element wires composed of metal, it is possible to protect the optical fiber and prevent it from fracture and the like.
(5) In any of the above (1) to (4), the measurement part may include a material to secure at least a part of the optical fiber in place in the optical fiber arrangement part.

By securing at least a part of the optical fiber in place by the material to secure the optical fiber, it is possible to prevent positional displacement of the optical fiber in the optical fiber arrangement part after installation of the optical fiber therein. Therefore, after the optical fiber is installed, it is possible to enhance the positional accuracy during measurement of strain and the like.
(6) In the above (5), at Least a Part of the Material to Secure the optical fiber may have a grid shape in the plane view.

When the material to secure the optical fiber has a grid shape, a number of points at which the material to secure the optical fiber contacts the optical fiber can be increased, and the optical fiber can be easily secured to the material to secure the optical fiber.
(7) In any of the above (1) to (6), the measurement part may further include a scattered light measurement device connected to the optical fiber.

By providing the measurement part with the scattered light measurement device connected to the optical fiber, it is possible to easily measure strain and the like along the longitudinal direction of the optical fiber. The scattered light measurement device does not need to be constantly connected to the optical fiber, and may be detachably configured to be connected only at the time of measurement.
(8) In any of the above (1) to (7), the optical fiber arrangement part may be arranged along the surface of a slope, and the measurement device may further include a processor configured to calculate a measurement value including one or more selected from strain, temperature, or vibration of the slope from the measurement data obtained by the measurement part.

By providing the measurement device according to one embodiment of the present disclosure with the processor, it is possible to easily calculate strain and the like over a wide range of the slope measured by the measurement part.
(9) In the above (8), the measurement part may perform measurements for a plurality of times at predetermined timings, and the processor may calculate temporal changes in the measurement values of the slope.

By the measurement part performing measurements for a plurality of times and the processor calculating temporal changes in the measurement values, it is possible to evaluate changes in the state of a slope or of a concrete structure when a concrete structure is provided on the slope, from the measurement values.
(10) In the above (9), the measurement device may further include an alarm function configured to issue an alarm when a degree of the temporal change in the measurement value of the slope calculated by the processor exceeds a predetermined range.

By providing the measurement device according to one embodiment of the present disclosure with the alarm function, it is possible to promptly warn an operator, a manager, or the like when a problem occurs in the state of a slope.
(11) In any of the above (1) to (10), the memory may be configured to record positional information of the optical fiber in the optical fiber arrangement part on the slope, and the processor may be further configured to identify a position, at which the measurement value of the slope calculated by the processor is acquired, based on the positional information of the optical fiber stored in the memory.

By configuring the memory to record the positional information of the optical fiber on the slope to enable identifying, based on the positional information of the optical fiber, the position, at which the measurement value of the slope calculated by the processor is acquired, it is possible to evaluate the state of the slope particularly accurately.
(12) In any of the above (1) to (11), the optical fiber may have deviated sections arranged along the longitudinal direction of the optical fiber at certain intervals, and the processor may be further configured to identify positions of the deviated sections in measurement data measured by the measurement part and identify the position, at which the measurement value on the slope calculated by the processor is acquired.

When the optical fiber have the deviated sections arranged along the longitudinal direction at constant intervals, strains attributable to the deviated sections are reflected in the measurement data. Therefore, it is possible to identify the positions of the deviated sections arranged along the longitudinal direction of the optical fiber in the measurement data measured by the measurement part. Then, by enabling identifying, based on the identified positions of the deviated sections, the position, at which the measurement value of the slope calculated by the processor is acquired, it is possible to evaluate the state of the slope particularly accurately.
(13) A measurement method according to one embodiment of the present disclosure includes a measurement step of measuring, by a measurement device, measurement data including one or more selected from strain, temperature, or vibration on a slope, wherein the measurement device includes a measurement part including: an optical fiber arrangement part having a planar shape and arranged along a surface of the slope; and a scattered light measurement device, wherein the measurement part includes: an optical fiber arranged in the optical fiber arrangement part; and a longitudinal protective material, at least a part of the optical fiber being arranged along the longitudinal direction of the protective material, and a part of a surface of the optical fiber being covered with the protective material, wherein the optical fiber is connected to the scattered light measurement device, and wherein, in the measurement step, the measurement data on the slope along the longitudinal direction of the optical fiber is measured by oscillating scattered light emitted into the optical fiber from the scattered light measurement device.

Since the measurement method according to one embodiment of the present disclosure involves the measurement part including the optical fiber arrangement part having a planar shape, it is possible to perform measurement by installing the optical fiber arrangement part on, for example, a slope and the like. In the measurement step, the optical fiber arranged in the optical fiber arrangement part can measure measurement data including one or more selected from strain, temperature, or vibration along the longitudinal direction of the optical fiber. Therefore, the measurement method according to one embodiment of the present disclosure can measure one or more measurement data selected from strain, temperature, or vibration over a wide range of the entirety of the optical fiber arrangement part in which the optical fiber is arranged.

In addition, by providing the measurement part with the protective material, arranging at least a part of the optical fiber along the longitudinal direction of the protective material, and covering a part of a surface of the optical fiber by the protective material, it is possible to prevent the optical fiber from fracture and the like.
(14) In the above (13), the slope and the optical fiber arrangement part may be covered with a concrete structure. In the measurement step, the measurement data along the longitudinal direction of the optical fiber may be measured for a plurality of times at the predetermined intervals, using the optical fiber. The measurement method may include a first determination step of determining deformations in the concrete structure from temporal changes in the measurement data along the longitudinal direction of the optical fiber measured in the measurement step.

When the concrete structure is deformed, this affects temporal changes in, for example, strain and temperature distribution, among measurement values along the longitudinal direction of the optical fiber. Therefore, it is possible to determine presence or absence of deformation in the concrete structure, by measuring temporal changes in the distributions of measurement values, such as strain, temperature, and the like, along the longitudinal direction of the optical fiber.
(15) In the above (13), the measurement part may include at least two optical fibers, each of which is the optical fiber, arranged in parallel in the optical fiber arrangement part. The slope and the optical fiber arrangement part may be covered with a concrete structure. In the measurement step, strain along the longitudinal direction of the optical fiber may be measured using at least two optical fibers arranged in parallel. The measurement method may include a second determination step of determining that deformations have occurred in the concrete structure in a case where a difference between the strain values measured using the at least two optical fibers arranged in parallel is equal to or greater than a predetermined value.

Strains measured using the at least two optical fibers arranged in parallel and the distributions of the strains are substantially the same as each other unless a large external force is applied to the optical fibers to cause deformation and the like in the optical fibers. Therefore, when strains are measured for the at least two optical fibers arranged in parallel, and a difference between the strains measured using the at least two optical fibers and the distributions of the strain are large, it means that the optical fibers have been largely bent. Therefore, in a case where there are large differences between the strains measured using the at least two optical fibers and between the distributions of the strains, it can be determined that, for example, the concrete structure installed to cover the slope has been deformed.
(16) In any of the above (13) to (15), the slope and the optical fiber arrangement part may be covered with a concrete structure, In the measurement step, vibration of the slope along the longitudinal direction of the optical fiber may be measured. The measurement method may include a third determination step of determining a gap between the concrete structure and the slope from a distribution of the measured vibration along the longitudinal direction of the optical fiber.

A gap might occur between a slope covered with a concrete structure and the concrete structure, as soil on the slope might be washed away by intrusion of water due to rain or the like. When a gap occurs, a change occurs in the state of the vibration. Therefore, by measuring the distribution of the vibration along the longitudinal direction of the optical fiber, it is possible to determine presence or absence of a gap between the concrete structure and the slope.
(17) in Any of the Above (13) to (16), the Slope and the Optical fiber arrangement part may be covered with a concrete structure. In the measurement step, a temperature of the slope along the longitudinal direction of the optical fiber may be measured for a plurality of times at predetermined time intervals. The measurement method may include a fourth determination step of determining a gap between the concrete structure and the slope from temporal changes in the measured temperature along the longitudinal direction of the optical fiber.

A gap might occur between a slope covered with a concrete structure and the concrete structure, as soil on the slope might be washed away by intrusion of water due to rain or the like. Such a gap affects a temporal change in the temperature distribution. Therefore, by measuring a temporal change in the temperature distribution along the longitudinal direction of the optical fiber, it is possible to determine presence or absence of a gap between the concrete structure and the slope.
(18) A manufacturing method for measurement devices according to one embodiment of the present disclosure includes an optical fiber arrangement step of arranging an optical fiber along the surface of the slope to form an optical fiber arrangement part having a planar shape, and an optical fiber position recording step of recording the position of the optical fiber in the optical fiber arrangement part, wherein the optical fiber arrangement part further includes a longitudinal protective material, at least a part of the optical fiber is arranged along a longitudinal direction of the protective material, and a part of a surface of the optical fiber is covered with the protective material.

According to the manufacturing method for measurement devices according to one embodiment of the present disclosure, it is possible to manufacture a measurement device including a measurement part including an optical fiber arrangement part having a planar shape and including an optical fiber arranged along a surface of a slope. Therefore, according to the manufacturing method for measurement devices according to one embodiment of the present disclosure, it is possible to manufacture a measurement device capable of measuring one or more measurement data selected from strain, temperature, or vibration over a wide range of the entirety of the optical fiber arrangement part in which the optical fiber is arranged.

Further, by providing the measurement part with the protective material, arranging at least a part of the optical fiber along the longitudinal direction of the protective material, and covering a part of a surface of the optical fiber with the protective material, it is possible to prevent the optical fiber from fracture and the like.

### Details of Embodiment of Present Disclosure

Specific examples of a measurement device, a measurement method, and a manufacturing method for measurement devices according to an embodiment of the present disclosure (hereinafter referred to as “the present embodiment”) will be described below with reference to the drawings. The present disclosure is not limited to these examples, is represented by the claims, and is intended to include all modifications within the equivalent meaning and scope of the claims.

In this specification, there are cases where first, second, and the like are affixed to the names of the members to be described. For example, the members are denoted like a first position identifying part and a second position identifying part. First and second affixed to the position identifying parts are denoted only to identify the respective members and to prevent confusion in the description, and do not represent location or priority. When there is no possibility of confusion or when they are collectively referred to, they can be denoted as the position identifying parts.

### [1] Measurement Device

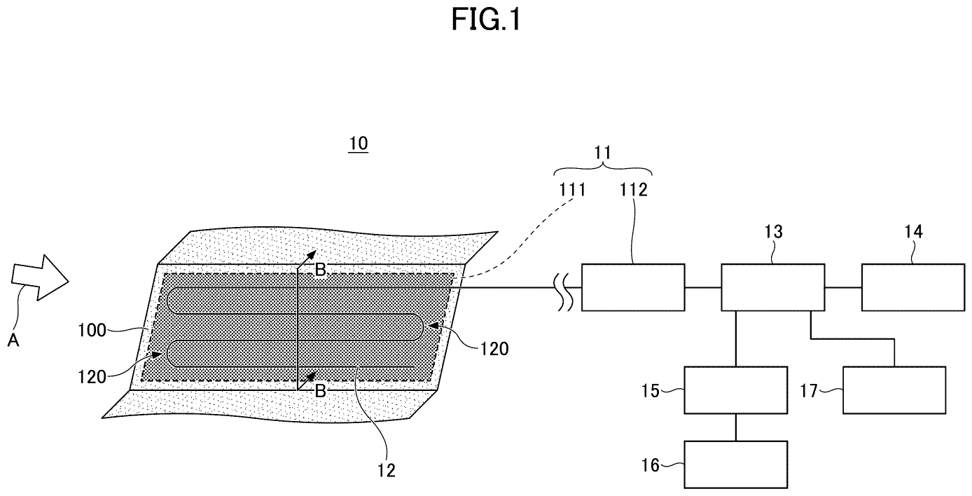

A configuration example of a measurement device of the present embodiment will be described with reference to FIGS. 1, 2, 3, 4A, 4B, 4C, 5A, 5B, and 6.

FIG. 1 is an oblique view of the measurement device of the present embodiment installed on a slope.

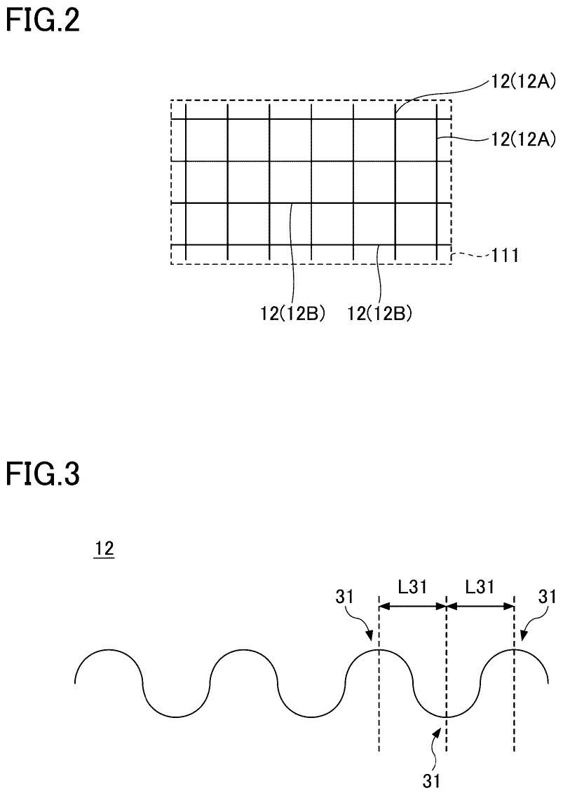

FIG. 2 is a schematic view of a modified example of the arrangement of optical fibers when an optical fiber arrangement part is viewed along the block arrow A in FIG. 1.

FIG. 3 is an explanatory diagram of an optical fiber when it has deviated sections arranged along the longitudinal direction thereof at constant intervals.

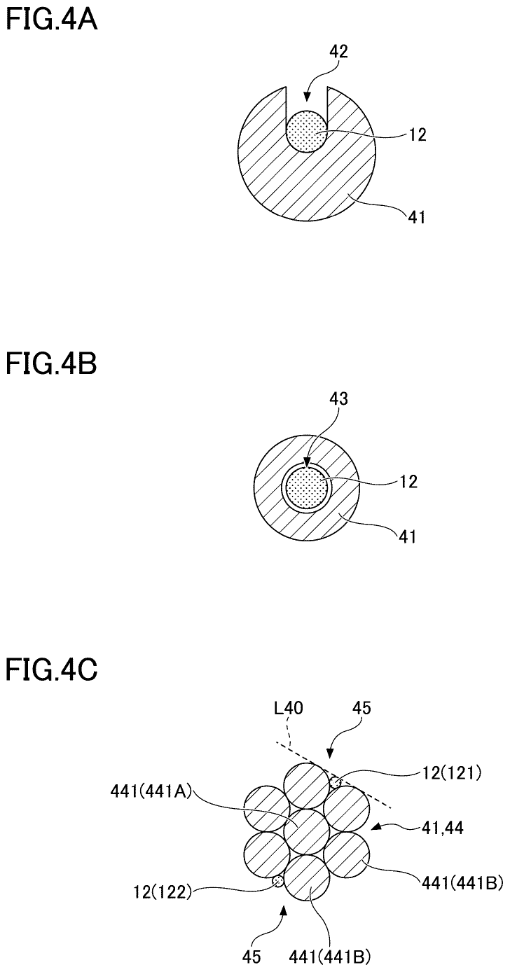

FIG. 4A, FIG. 4B and FIG. 4C are schematic cross-sectional views of a protective material and an optical fiber in a plane orthogonal to the longitudinal direction thereof when the optical fiber is installed in the protective material.

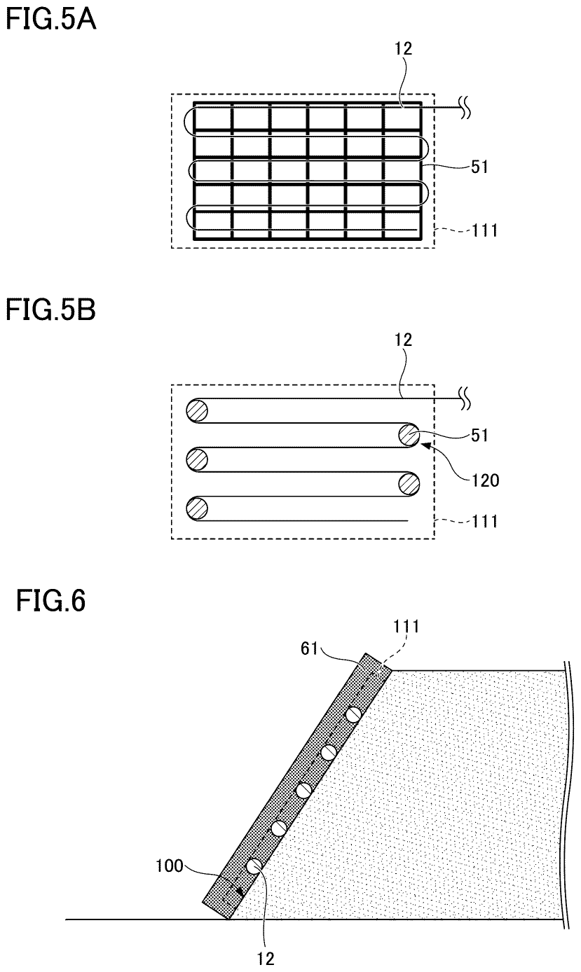

FIG. 5A and FIG. 5B are explanatory diagrams of a material to secure the optical fiber when the optical fiber arrangement part is viewed along the block arrow A in FIG. 1.

FIG. 6 is a schematic cross-sectional view taken along the line B-B in FIG. 1 when the measurement device has a concrete structure, and is a cross-sectional view in a plane perpendicular to the longitudinal direction of the optical fiber when the measurement device of the present embodiment includes a protective material. FIG. 4 are explanatory views of the configuration of the measurement device of the present embodiment.

A measurement device 10 of the present embodiment may include a measurement part 11 including an optical fiber arrangement part 111 having a planar shape. The measurement part 11 may include an optical fiber 12 arranged in the optical fiber arrangement part 111. The measurement part 11 can measure measurement data (parameter) including one or more selected from strain, temperature, or vibration, using the optical fiber 12.

Since the measurement device 10 of the present embodiment includes the measurement part 11 including the optical fiber arrangement part 111 having a planar shape, it can perform measurement with the optical fiber arrangement part 111 installed on, for example, a slope 100. The optical fiber 12 arranged in the optical fiber arrangement part 111 can measure measurement data including one or more selected from strain, temperature, or vibration along the longitudinal direction of the optical fiber. Therefore, the measurement device 10 of the present embodiment can measure one or more measurement data selected from strain, temperature, or vibration over a wide range of the entirety of the optical fiber arrangement part in which the optical fiber is arranged.

In this specification, the term “slope” means inclined ground, and encompasses, for example, artificial inclined ground formed by excavation or embankment.

### (1) Optical Fiber Arrangement Part

### (1-1) Arrangement of Optical Fiber in Optical Fiber Arrangement Part

The optical fiber arrangement part 111 means a virtual area in which the optical fiber 12 is arranged, and no specific member needs to be prepared as the optical fiber arrangement part 111. Although the arrangement of the optical fiber 12 in the optical fiber arrangement part 111 is not particularly limited, for example, as shown in FIG. 1, the optical fiber 12 may have a plurality of deviated sections 120 in the optical fiber arrangement part 111.

By arranging the optical fiber 12 in the optical fiber arrangement part 111 to have the plurality of deviated sections 120, it is possible to arrange one optical fiber in a planar shape. Therefore, strain and the like can be measured over a wide range with one optical fiber, and the number of scattered light measurement devices 112 required for the measurement can be reduced.

Further, the measurement part 11 may include a plurality of optical fibers 12. When the measurement part 11 includes a plurality of optical fibers 12, the plurality of optical fibers 12 may be arranged such that at least some of the plurality of optical fibers 12 intersect each other when the optical fiber arrangement part 111 is viewed from above the optical fiber arrangement part 111 in the vertical direction.

FIG. 2 shows a schematic diagram of a modified example of the arrangement of the optical fiber 12 when the optical fiber arrangement part 111 is viewed from above the optical fiber arrangement part 111 in the vertical direction, that is, when viewed along the block arrow A in FIG. 1. As shown in FIG. 2, the measurement part 11 may include a plurality of optical fibers 12. Although FIG. 2 shows an example including optical fibers 12A arranged vertically and optical fibers 12B arranged horizontally, this is non-limiting. For example, the measurement part 11 may include either the optical fibers 12A or the optical fibers 12B.

For example, as shown in FIG. 2, when the optical fiber arrangement part 111 is viewed from above the optical fiber arrangement part 111 in the vertical direction, the plurality of optical fibers 12 may be arranged such that at least some of the plurality of optical fibers 12 intersect each other.

By providing the measurement part 11 with the plurality of optical fibers 12 and arranging the optical fibers 12 in the optical fiber arrangement part 111 such that at least some of the optical fibers intersect each other, it is possible to arrange the optical fibers to form a plane. Therefore, the measurement of strain and the like can be performed over the entirety of the optical fiber arrangement part 111 without omission.

### (1-2) Optical Fiber

As the optical fiber 12, for example, one that includes a core and cladding may be used. Examples of the material of the core and the cladding include plastics and quartz glass. As the optical fiber, it is possible to use one or more selected from: an optical fiber element wire including a primary coating on the outer periphery of cladding; an optical fiber core further including a secondary coating; an optical fiber cord further including a reinforcing material on the outer periphery of the secondary coating and a sheath covering the outer periphery of the reinforcing material; and the like.

Examples of the material of the primary coating include ultraviolet curable resin. Examples of the material of the secondary coating include flame-retardant polyester elastomer. Examples of the material of the reinforcing material include glass fiber, carbon fiber, aramid fiber, and the like. Examples of the material of the sheath include flame-retardant polyolefin, such as flame-retardant polyethylene and the like, flame-retardant cross-linked polyolefin, such as flame-retardant cross-linked polyethylene and the like, heat-resistant vinyl, and the like.

The type of optical fiber used is not particularly limited, and can be selected in accordance with the types of measurement parameters to be measured, such as strain and the like, the measurement method, the type of scattered light used in the measurement, and the like. As the optical fiber, for example, one or more optical fibers selected from a single-mode optical fiber, a multimode optical fiber, and a polarization-maintaining optical fiber may be used.

The outer diameter of the optical fiber 12 is not particularly limited, yet may be, for example, 1.5 mm or less, and 1.0 mm or less.

When the outer diameter of the optical fiber 12 is 1.5 mm or less, it is easy to install the optical fiber 12. Further, the optical fiber 12 may be disposed in a groove 42 in a protective material 41 or the like, which can prevent the groove 42 or the like from becoming excessively oversized.

The lower limit value of the outer diameter of the optical fiber 12 is not particularly limited. Yet, the outer diameter of the optical fiber 12 may be 0.235 mm or greater, or 0.8 mm or greater. When the outer diameter of the optical fiber 12 is 0.235 mm or greater, the durability of the optical fiber 12 can be enhanced. When installing and securing the optical fiber 12 on a measurement surface, such as a slope and the like, heat or external force may be applied to the optical fiber. Here, when the outer diameter of the optical fiber 12 is 0.235 mm or greater, it is possible to prevent fracture during installation and the like of the optical fiber 12.

As shown in FIG. 3, the optical fiber 12 may have deviated sections 31 arranged along the longitudinal direction of the optical fiber at constant intervals. That is, the optical fiber 12 may have deviated sections 31 cyclically such that the distance L31 between the adjacent deviated sections 31 is constant.

Since the optical fiber 12 has the deviated sections 31 arranged along the longitudinal direction of the optical fiber at constant intervals, strain attributable to the deviated sections 31 is reflected in measurement data measured using the optical fiber 12. Therefore, the positions of the deviated sections 31 arranged along the longitudinal direction of the optical fiber 12 in the measurement data measured using the optical fiber 12 can be identified. Thus, based on the identified positions of the deviated sections 31, it is possible to identify the position at which a measurement value is acquired. Thus, the measurement can be performed particularly accurately.

### (1-3) Protective Material

As shown in FIGS. 4A, 4B, and 4C, the measurement part 11 can further include a longitudinal protective material 41. FIGS. 4A, 4B, and 4C are cross-sectional views of the protective material 41 and the optical fiber 12 in a plane perpendicular to the longitudinal direction of the protective material 41 and the optical fiber 12.

When the measurement part 11 includes the protective material 41, at least a part of the optical fiber 12 may be arranged along the longitudinal direction of the protective material 41, and a part of the surface of the optical fiber 12 may be covered with the protective material 41.

By providing the measurement part 11 with the protective material 41, arranging at least a part of the optical fiber 12 along the longitudinal direction of the protective material 41, and covering a part of the surface of the optical fiber 12 with the protective material 41, it is possible to prevent the optical fiber 12 from fracture and the like.

For this purpose, the protective material 41 may have a groove or a cavity serving as an optical fiber housing in which the optical fiber 12 is arranged.

As shown in FIG. 4A, the protective material 41 may have the groove 42 along the longitudinal direction of the protective material 41, and the optical fiber 12 may be housed in the groove 42.

Further, as shown in FIG. 4B, the protective material 41 may have a columnar cavity 43 arranged along the longitudinal direction of the protective material 41. In the case of FIG. 4B, the optical fiber 12 is completely covered with the protective material 41 as the optical fiber 12 is arranged in the cavity 43 of the protective material 41.

As shown in FIG. 4C, the protective material 41 may include a stranded wire 44 formed by twisting element wires 441, and the optical fiber 12 may be arranged in a helical groove 45 of the stranded wire 44.

When the protective material 41 is the stranded wire 44, it is easy to bend the protective material 41. Therefore, the protective material 41 in which the optical fiber 12 is arranged can be easily deformed to conform to the shape of the optical fiber arrangement part 111, which makes it possible to lay the optical fiber throughout the optical fiber arrangement part 111 easily.

When the protective material 41 includes the stranded wire 44, the material of the element wires 441 is not particularly limited, and the element wires 441 may be resin stranded wires or metal stranded wires. However, the element wires 441 may be composed of metal from the viewpoint of enhancing the toughness of the protective material 41. Therefore, the protective material 41 may include the stranded wire 44 formed by twisting the element wires 441 composed of metal, and the optical fiber 12 may be arranged in the helical groove 45 of the stranded wire 44.

When the element wires 441 are composed of metal, that is, when the protective material 41 is a metal wire as well, it is easy to bend the protective material 41 because the protective material 41 includes the stranded wire 44. Therefore, the protective material 41 in which the optical fiber 12 is arranged can be easily deformed to conform to the shape of the optical fiber arrangement part 111, which makes it possible to lay the optical fiber throughout the optical fiber arrangement part 111 easily.

Further, by arranging the optical fiber 12 in the helical groove 45 of the stranded wire 44 serving as the protective material 41 of the optical fiber 12 and formed by twisting the element wires 441 composed of metal, it is possible to protect and prevent the optical fiber 12 from fracture and the like. By arranging the optical fiber 12 in the helical groove 45 of the stranded wire 44 formed by twisting the element wires 441 composed of metal, it is possible to particularly protect and prevent the optical fiber from fracture and the like.

As shown in FIG. 4C, the optical fiber 12 may be arranged such that the entirety of the optical fiber is housed in a region surrounded by a tangent line L40 of two element wires 441 adjacent to each other along the outer periphery of the stranded wire 44 and the two element wires 441 adjacent to each other along the outer periphery of the stranded wire 44. The tangent line L40 is a tangent line that is in contact with the outer periphery of the stranded wire 44. The two element wires 441 forming the region described above are two element wires 441 that are in contact with the tangent line L40.

By arranging the optical fiber 12 in the region surrounded by the tangent line L40 and the two element wires 441 adjacent to each other along the outer periphery of the stranded wire 44, the optical fiber 12 is protected by the two element wires 441, making it difficult for other members to directly contact the optical fiber 12. This makes it difficult for an external force to be directly applied to the optical fiber 12, particularly making it possible to prevent the optical fiber 12 from fracture and the like.

As shown in FIGS. 4A and 4C, by exposing a part of the optical fiber 12 while covering a part of the optical fiber 12 with the protective material 41, it is possible to facilitate taking out the optical fiber 12 from a desirable point of the protective material 41 and connecting the optical fiber 12 to a scattered light measurement device. In addition, for example, even if the optical fiber 12 undergoes being broken and the like, it is easy to perform operations, such as re-connection and the like.

The number and structure of the element wires 441 included in the stranded wire 44 are not particularly limited. For example, the number of the element wires 441 included in the stranded wire 44 may be 7, 19, and the like. When the number of the element wires 441 included in the stranded wire 44 is 7, the structure of the stranded wire 44 may be a single-core structure in which six outer peripheral element wires 441B are helically twisted on the outer periphery of one central element wire 441A, as shown in FIG. 4C. In this case, the outer peripheral element wires 441B are located on the outermost periphery of the stranded wire 44. FIG. 4C shows an example in which element wires having the same element wire diameter are used as the central element wire 441A and the outer peripheral element wires 441B. However, this is a non-limiting embodiment. For example, the element wire diameter of the central element wire 441A and the element wire diameter of the outer peripheral element wires 441B may be different.

The material of the protective material 41 is not particularly limited. Yet, the protective material 41 may be composed of metal in order to protect the optical fiber 12. The type of the metal used for the protective material 41 is not particularly limited. One or more selected from, for example, aluminum, aluminum alloy, steel, and the like may be used.

When the protective material 41 is composed of metal, it is possible to enhance the toughness of the protective material 41, and to prevent the protective material 41 and the optical fiber 12 arranged in the protective material 41 from fracture and the like.

The optical fiber 12 may be secured to the protective material 41 by resin and the like. In this case, ultraviolet-curable resin may be used as the resin.

In order to protect the protective material 41 and the optical fiber 12, at least a part of the surfaces of the protective material 41 and the optical fiber 12 may be coated with an anticorrosive coating.

The material of the anticorrosive coating is not particularly limited. Yet, for example, a resin having excellent corrosion resistance may be used. Examples of the resin used as the anticorrosive coating include one or more selected from epoxy resins, polyethylene resins and the like. The anticorrosive coating may include a plurality of layers, and the respective layers may be composed of the same material or different materials.

### (1-4) Material to Secure Optical Fiber

The measurement part 11 may have a material to secure at least a part of the optical fiber 12 in place in the optical fiber arrangement part 111.

By securing at least a part of the optical fiber 12 in place by a material 51 to secure the optical fiber, it is possible to prevent positional displacement of the optical fiber 12 in the optical fiber arrangement part 111 after the optical fiber 12 is installed. Therefore, after the optical fiber 12 is installed, it is possible to enhance the positional accuracy during measurement of strain and the like.

FIGS. 5A and 5B show examples of configurations in which the material 51 to secure the optical fiber is provided in the optical fiber arrangement part 111, which are observed when the optical fiber arrangement part 111 is viewed from above the optical fiber arrangement part 111 in the vertical direction, that is, viewed along the block arrow A in FIG. 1. FIG. 5B is a modified example of FIG. 5A. Thus, the following description will mainly refer to FIG. 5A.

The material 51 to secure the optical fiber can be disposed, for example, on the surface of the slope 100. At least a part of the material 51 to secure the optical fiber may have, for example, a grid shape as shown in FIG. 5A. That is, at least a part of the material 51 to secure the optical fiber may have a grid shape when the optical fiber arrangement part 111 is viewed from above the optical fiber arrangement part 111 in the vertical direction.

The grid shape is not limited to a rectangular grid shape as shown in FIG. 5A, but may be such a shape as a rhombic shape, a polygonal shape, and the like.

When the material 51 to secure the optical fiber has a grid shape, the material 51 to secure the optical fiber and the optical fiber 12 can be brought into contact with each other at many locations, which facilitates securing of the optical fiber 12 to the material 51 to secure the optical fiber.

The slope 100 and the optical fiber arrangement part 111 may be blown with mortar or concrete and covered with a concrete structure. When the material 51 to secure the optical fiber has a grid shape, the material 51 to secure the optical fiber may support the concrete structure.

As shown in FIG. 5B, the material 51 to secure the optical fiber may be a rock bolt and the like installed on the slope 100 to intersect the slope 100. For example, when the optical fiber 12 has the plurality of deviated sections 120 as shown in FIG. 5B, the material 51 to secure the optical fiber, serving as the rock bolt, may be placed on the deviated sections 120.

By securing the deviated sections 120 with the material 51 to secure the optical fiber, such as a rock bolt and the like, it is possible to acquire a reaction force against the shape of the ground of the slope 100 and to enhance the sensitivity for measuring strain and the like.

The material of the material 51 to secure the optical fiber is not particularly limited. For example, metal may be used. Examples of the metal include steel, stainless steel, aluminum, aluminum alloy, and the like.

### (2) Scattered Light Measurement Device

The measurement part 11 of the present embodiment may further include the scattered light measurement device 112 connected to the optical fiber 12.

By providing the measurement part 11 with the scattered light measurement device 112 connected to the optical fiber 12, it is possible to measure strain and the like along the longitudinal direction of the optical fiber 12 easily. The scattered light measurement device 112 does not need to be constantly connected to the optical fiber 12, and may be detachably configured to be connected only at the time of measurement.

When the measurement part 11 includes a plurality of optical fibers 12, the scattered light measurement device 112 may include a switching device for switching between the optical fibers 12 to which the scattered light measurement device 112 oscillates scattered light to irradiate the optical fibers with the scattered light, in order to be able to switch between the optical fibers used for the measurement.

The measurement part 11 may perform measurements for a plurality of times at predetermined timings. The predetermined timings are not particularly limited. For example, measurement may be performed at predetermined fixed intervals, or may be performed at specific timings, such as in the morning, at night, and the like within a specific period, such as a day, a month, a year, and the like.

The method for measuring strain and the like by the scattered light measurement device 112 will be described in “Measurement Method”.

### (3) Calculator

The measurement device 10 of the present embodiment may further include a calculator 13.

The optical fiber arrangement part 111 may be arranged, for example, along the surface of the slope 100. The measurement part 11 may calculate a measurement value including one or more selected from strain, temperature, or vibration the slope surface 100 from the measurement data obtained by the measurement part 11.

By providing the measurement device 10 with the calculator 13, it is possible to calculate strain and the like easily over a wide range in the slope 100 that is measured by the measurement part 11.

In a case where the measurement part 11 performs measurements for a plurality of times at predetermined timings, the calculator 13 may calculate temporal changes in the measurement values, such as strain and the like of the slope 100.

By the measurement part 11 performing measurements for a plurality of times and the calculator 13 calculating temporal changes in the measurement values, such as strain and the like, it is possible to evaluate changes in the state of the slope 100, or of a concrete structure when a concrete structure is provided on the slope 100, from the measurement value.

The calculator 13 may include a CPU, which is an arithmetic processing unit for performing necessary calculations, a RAM and a ROM, which are main memory devices, an auxiliary memory device, an input/output interface, a display device, which is an output device, and the like. The CPU, the main memory devices, the auxiliary memory device, the input/output interface, and the output device included in the calculator 13 can be connected to each other by a bus. All of the these components included in the calculator 13 do not need to be included in the same housing, and for example, the auxiliary memory device and the display device may be provided externally. The auxiliary memory device is a memory device, such as an SSD, an HDD, and the like.

CPU stands for Central Processing Unit, RAM stands for Random Access Memory, and ROM stands for Read Only Memory. SSD stands for Solid State Drive, and HDD stands for Hard Disk Drive.

Examples of the input/output interface include a wired or wireless interface for exchanging measurement data. Examples of the input/output interface include an interface for exchanging measurement data with the scattered light measurement device 112 of the measurement part 11 and an interface for controlling an alarm function 14. Further, for example, for the purpose of receiving a calculated measurement value at a remote location, the input/output interface may include a communication port and the like for transmitting the measurement value to the remote location via a network.

Examples of the input/output interface also include a user interface, such as a touch panel, a keyboard, operation buttons, and the like for selecting data used for calculation by the calculator 13.

The main memory devices and the auxiliary memory device may store a program for calculating strain and the like from measurement data measured by the measurement part 11. Further, the main memory devices and the auxiliary memory device may store data, such as strain and the like calculated by the calculator 13, such that the data can be used for calculating a temporal change in strain and the like.

The calculator 13 may be formed by, for example, a personal computer (PC) and the like. Therefore, each function of the calculator 13 may be executed by cooperation between software and hardware by a previously stored program being executed by the CPU in an information processing apparatus, such as a personal computer and the like.

### (4) Alarm Function

The measurement device 10 of the present embodiment may further include the alarm function 14. The alarm function 14 can issue an alarm when the degree of a temporal change in a measurement value, such as strain and the like of the slope 100, calculated by the calculator 13 exceeds a predetermined range.

By providing the measurement device 10 of the present embodiment with the alarm function 14, it is possible to promptly warn an operator, a manager, and the like when a problem occurs in the state of the slope 100.

The alarm function 14 may include, for example, a display, a lamp, a buzzer, and the like to be able to issue an alarm such that an operator or a manager can recognize that a state change has occurred in the slope 100. The alarm function 14 may be disposed, for example, in the calculator 13, or may be the display or the like of the calculator 13.

### (5) Recorder, First Position Identifying Part, Second Position Identifying Part

As shown in FIG. 6, the measurement device 10 of the present embodiment may include a concrete structure 61 disposed to cover the slope 100 and the optical fiber arrangement part 111. FIG. 6 corresponds to a cross-sectional view taken along the line B-B in FIG. 1 when the measurement device 10 includes the concrete structure 61. The optical fiber arrangement part 111 may be covered with planting or soil instead of the concrete structure 61.

The concrete structure 61 may be manufactured by blowing the slope 100 and the optical fiber arrangement part 111 with mortar or concrete and leaving the mortar or concrete to cure.

When the optical fiber arrangement part 111 is covered with the concrete structure 61 or the like, the optical fiber 12 is not visible from outside due to the concrete structure 61.

Therefore, the measurement device 10 of the present embodiment may include a recorder 15 for recording positional information of the optical fiber 12 in the optical fiber arrangement part 111 on the slope 100.

The measurement device 10 of the present embodiment may further include a first position identifying part 16 for identifying the position, at which a measurement value of the slope calculated by the calculator 13 is acquired, based on the positional information of the optical fiber stored in the recorder 15.

By recording the positional information of the optical fiber 12 on the slope 100 in the recorder 15 to enable identifying, based on the positional information of the optical fiber 12, the position at which a measurement value of the slope 100 calculated by the calculator 13 is acquired, it is possible to particularly accurately evaluate the state of the slope 100.

As described with reference to FIG. 3, the optical fiber 12 may have the deviated sections 31 arranged along the longitudinal direction of the optical fiber at constant intervals.

Thus, the measurement device 10 of the present embodiment may also include a second position identifying part 17. The second position identifying part 17 can identify the positions of the deviated sections 31 in measurement data measured by the measurement part 11 and identify the position at which a measurement value of the slope 100 calculated by the calculator 13 is acquired.

As the optical fiber 12 has the deviated sections 31 arranged along the longitudinal direction of the optical fiber at constant intervals, strains attributable to the deviated sections 31 are reflected in the measurement data. Therefore, the positions of the deviated sections 31 arranged along the longitudinal direction of the optical fiber 12 in the measurement data measured by the measurement part 11 can be identified. Then, by enabling identifying, based on the identified positions of the deviated sections 31, the position at which a measurement value of the slope calculated by the calculator 13 is acquired, it is possible to particularly accurately evaluate the state of the slope.

The measurement device 10 of the present embodiment may include only one selected from the first position identifying part 16 and the second position identifying part 17, or may include both of the first position identifying part 16 and the second position identifying part 17. When the measurement device 10 includes the first position identifying part 16 and the second position identifying part 17, the position of the optical fiber 12 on the slope 100 can be identified particularly accurately.

The recorder 15, the first position identifying part 16, and the second position identifying part 17 may be provided individually, or may be an integrated device. Part or the whole of the calculator 13, the recorder 15, the first position identifying part 16, and the second position identifying part 17 may be an integrated device. Therefore, for example, the recorder 15 may be composed of the auxiliary memory device and the like of the calculator 13, and the first position identifying part 16 and the second position identifying part 17 may be composed of the CPU, the main memory devices, the auxiliary memory device, the input/output interface, the output device, and the like of the calculator 13.

Like the calculator 13, the recorder 15, the first position identifying part 16, and the second position identifying part 17 may include a CPU, which is as an arithmetic processing unit for performing necessary arithmetic operations, a RAM and a ROM, which are main memory devices, an auxiliary memory device, an input/output interface, a display device, which is an output device, and the like. Since the CPU and the like have been described regarding the calculator 13, description thereof will be omitted.

The recorder 15, the first position identifying part 16, and the second position identifying part 17 may be composed of, for example, a personal computer (PC) and the like. Accordingly, each function of the recorder 15, the first position identifying part 16, and the second position identifying part 17 may be executed by cooperation between software and hardware by a previously stored program being executed by the CPU in an information processing apparatus, such as a personal computer and the like.

Each process (each function) of the above-described embodiments is executed by a common circuit or a combination of a plurality of circuits (collectively referred to as circuitry). The circuitry may be configured by an integrated circuit or the like in which at least one memory, various analog circuits, and various digital circuits are combined in addition to at least one processor. The memory stores programs (instructions) that cause the processor to execute the function. The processor may execute the function in accordance with the program read from the memory, or may execute the function in accordance with a logic circuit designed in advance to execute the function. The processor may be various processors suitable for control of a computer (including a cloud server), such as a central processing unit (CPU), a graphics processing unit (GPU), a digital signal processor (DSP), a field programmable gate array (FPGA), and an application specific integrated circuit (ASIC). The processor mounted on each of physically separated computers may execute some or all of the functions in cooperation with each other via a network such as a local area network (LAN), a wide area network (WAN), or the Internet. The program may be installed in the memory from an external server device or the like via the network, or may be distributed in a state of being stored in a recording medium such as a compact disc read only memory (CD-ROM), a digital versatile disk read only memory (DVD-ROM), or a semiconductor memory and may be installed in the memory from the recording medium.

### [2] Measurement Method

A measurement method according to the present embodiment will be described. The measurement method according to the present embodiment can be performed using, for example, the measurement device according to one embodiment of the present disclosure. Thus, description of the particulars described with respect to the measurement device will be partially omitted.

### (1) Measurement Step

The measurement method of the present embodiment may include a measurement step.

In the measurement step, it is possible to measure a measurement value including one or more selected from strain, temperature, or vibration on a slope 100 by the measurement device 10.

The measurement device 10 may include a measurement part 11 including an optical fiber arrangement part 111 having a planar shape and arranged along the surface of the slope 100 and a scattered light measurement device 112.

The measurement part 11 may include an optical fiber 12 arranged in the optical fiber arrangement part 111, and the optical fiber 12 may be connected to the scattered light measurement device 112.

The measurement part 11 may further include a longitudinal protective material 41 arranged in the optical fiber arrangement part 111, and at least a part of the optical fiber 12 may be arranged along the longitudinal direction of the protective material 41, and a part of the surface of the optical fiber 12 may be covered with the protective material 41. Since the protective material 41 has already been described, description thereof is omitted.

In the measurement step, a measurement value, such as strain and the like of the slope 100 along the longitudinal direction of the optical fiber 12 may be measured by oscillating scattered light to the optical fiber 12 from the scattered light measurement device 112.

Since the measurement method of the present embodiment involves the measurement part 11 including the optical fiber arrangement part 111 having a planar shape, it is possible to perform measurement by installing the optical fiber arrangement part 111 on, for example, the slope 100 and the like. In the measurement step, a measurement value including one or more selected from strain, temperature, or vibration can be measured along the longitudinal direction of the optical fiber 12, using the optical fiber 12 arranged in the optical fiber arrangement part 111. Therefore, the measurement method of the present embodiment can measure one or more measurement data selected from strain, temperature, or vibration over a wide range of the entirety of the optical fiber arrangement part 111 in which the optical fiber 12 is arranged.

Further, by providing the measurement part 11 with the protective material 41, arranging at least a part of the optical fiber 12 along the longitudinal direction of the protective material 41, and covering a part of the surface of the optical fiber 12 with the protective material 41, it is possible to prevent the optical fiber 12 from fracture and the like.

The method for measuring measurement values, such as strain and the like using the optical fiber 12 in the measurement step will be described.

### (Measurement of Strain)

When measuring strain in the measurement step, strain at a desirably selected position along the longitudinal direction of the optical fiber and a strain distribution along the longitudinal direction of the optical fiber can be measured in the measurement step.

The scattered light used for measuring strain is not particularly limited. For example, one or more selected from Brillouin scattered light, Rayleigh scattered light, and Raman scattered light may be used.

The method for measuring strain is not particularly limited. Examples of the method include one or more selected from Brillouin Optical Correlation Domain Analysis (BOCDA), Brillouin Optical Time Domain Reflectometry (BOTDR), Fiber Bragg Grating (FBG), Brillouin Optical Time Domain Analysis (BOTDA), Brillouin Optical Correlation Domain Reflectometry (BOCDR), and the like.

The number of optical fibers used for measuring strain in the measurement step can be selected in accordance with the measurement method and the like. For example, when the measurement method is BOCDA or BOTDA, the number of optical fibers may be an even number equal to or greater than 2. When the measurement method is BOTDR, FBG, or BOCDR, the number of optical fibers may be 1 or greater.

### (Measurement of Temperature)

When measuring temperature in the measurement step, temperature at a desirably selected position along the longitudinal direction of the optical fiber, and a temperature distribution along the longitudinal direction of the optical fiber can be measured in the measurement step.

The scattered light used for temperature measurement is not particularly limited. For example, one or more selected from Brillouin scattered light, Rayleigh scattered light, and Raman scattered light may be used.

The method for measuring temperature is not particularly limited. Examples of the method include one or more selected from BOCDA, BOTDR, FBG, BOTDA, BOCDR, Raman Optical Time Domain Reflectometer (ROTDR), and the like.

The number of optical fibers used for measuring temperature in the measurement step can be selected in accordance with the measurement method and the like. For example, when the measurement method is BOCDA or BOTDA, the number of optical fibers may be an even number equal to or greater than 2. When the measurement method is BOTDR, FBG, BOCDR, or ROTDR, the number of optical fibers may be 1 or greater.

### (Measurement of Vibration)

When measuring vibration in the measurement step, Distributed Acoustic Sensing (DAS) can be performed using the optical fiber 12. In the measurement step, vibration around the optical fiber 12 and a vibration distribution can be measured.

The scattered light used for measuring vibration is not particularly limited. For example, Rayleigh scattered light may be used.

### (2) Determination Step

The measurement method of the present embodiment may include a determination step of determining the states of the slope 100 and of the concrete structure 61 covering the slope 100 and the optical fiber arrangement part 111 based on a measurement value measured in the measurement step.

A configuration example of the determination step will be described below.

### (2-1) First Configuration Example

In the case of a first configuration example, the measurement method may further include a first determination step.

As shown in FIG. 6, the slope 100 and the optical fiber arrangement part 111 may be covered with the concrete structure 61.

In this case, in the measurement step, measurement data along the longitudinal direction of the optical fiber 12 on the slope 100 can be measured for a plurality of times at predetermined intervals using the optical fiber. The number of optical fibers 12 used for the measurement is not particularly limited, and the measurement may be performed using, for example, one optical fiber 12. Further, the measurement may be performed using a plurality of optical fibers 12. Further, the intervals at which the measurements are performed are not particularly limited, and can be selected in accordance with the inclination angle of the slope, the surrounding environment, and the like.

In the first determination step, presence or absence of deformation in the concrete structure 61 can be determined from a temporal change in a measurement value along the longitudinal direction of the optical fiber 12 measured in the measurement step.

When the concrete structure 61 is deformed, this will affect temporal changes in, for example, strain and a temperature distribution, among the measurement values along the longitudinal direction of the optical fiber 12. Therefore, by measuring temporal changes in the distributions of the measurement values, such as strain, temperature, and the like along the longitudinal direction of the optical fiber 12, it is possible to determine presence or absence of deformation in the concrete structure 61.

### (2-2) Second Configuration Example

In the case of a second configuration example, the measurement method may further include a second determination step.

The measurement part 11 may include at least two optical fibers 12 arranged in parallel in the optical fiber arrangement part 111.

Specifically, for example, as shown in FIG. 4C, the measurement device 10 may further include the stranded wire 44 serving as the protective material 41, and a first optical fiber 121 and a second optical fiber 122 may be arranged in the helical grooves 45 of the stranded wire 44. The arrangement of the first optical fiber 121 and the second optical fiber 122 in the stranded wire 44 is not particularly limited, and they may be arranged in the same helical groove 45 or in different helical grooves 45. For example, as shown in FIG. 4C, the first optical fiber 121 and the second optical fiber 122 may be arranged in the helical grooves 45 at facing positions in a cross-section perpendicular to the longitudinal direction of the stranded wire 44.

Then, as shown in FIG. 6, the slope 100 and the optical fiber arrangement part 111 may be covered with the concrete structure 61.

In this case, in the measurement step, strains along the longitudinal direction of the optical fibers 12 can be measured using at least two optical fibers 12 arranged in parallel.

Then, in the second determination step, it can be determined that the concrete structure 61 is deformed when the difference between the strains measured using the at least two optical fibers 12 arranged in parallel is equal to or greater than a predetermined value. In the second determination step, it can be determined that the concrete structure 61 is not deformed and normal when the difference between the strains measured using the at least two optical fibers 12 arranged in parallel is less than the predetermined value.

The strains measured using the at least two optical fibers 12 arranged in parallel and the distributions of the strains are substantially the same as each other unless a large external force is applied to the optical fibers 12 to cause deformation and the like in the optical fibers. Therefore, measurement of strains for the at least two optical fibers 12 arranged in parallel reveals that there are large differences between the strains measured using the at least two optical fibers 12 and between the distributions of the strains, it means that the optical fibers 12 have been largely bent. Therefore, when there are large differences between the strains measured using the at least two optical fibers 12 and between the distributions of the strains, it can be determined that, for example, the concrete structure 61 installed to cover the slope 100 has been deformed.

### (2-3) Third Configuration Example

In the case of a third configuration example, the measurement method may further include a third determination step.

As shown in FIG. 6, the slope 100 and the optical fiber arrangement part 111 may be covered with the concrete structure 61.

In this case, vibration of the slope 100 along the longitudinal direction of the optical fiber 12 can be measured using the optical fiber in the measurement step.

Then, in the third determination step, presence or absence of a gap between the concrete structure 61 and the slope 100 can be determined from the distribution of the vibration along the longitudinal direction of the optical fiber 12 measured in the measurement step.

A gap might occur between the slope 100 covered with the concrete structure 61 and the concrete structure 61, as soil on the slope might be washed away by intrusion of water due to rain or the like. When a gap occurs, a change occurs in the state of vibration. Thus, by measuring the distribution of vibration along the longitudinal direction of the optical fiber 12, it is possible to determine presence or absence of a gap between the concrete structure 61 and the slope 100.

### (2-4) Fourth Configuration Example

In the case of a fourth configuration example, the measurement method may further include a fourth determination step.

As shown in FIG. 6, the slope 100 and the optical fiber arrangement part 111 may be covered with the concrete structure 61.

In this case, in the measurement step, the temperatures of the slope 100 along the longitudinal direction of the optical fiber 12 can be measured for a plurality of times at predetermined time intervals, that is, at a predetermined cycle. The cycle at which the measurement is performed is not particularly limited, and can be selected in accordance with the inclination angle of the slope, the surrounding environment, and the like.

In the fourth determination step, presence or absence of a gap between the concrete structure 61 and the slope 100 can be determined from temporal changes in the temperatures along the longitudinal direction of the optical fiber 12 measured in the measurement step.

A gap might occur between the slope 100 covered with the concrete structure 61 and the concrete structure 61, as soil on the slope might be washed away by intrusion of water due to rain or the like. Since the occurrence of a gap affects the temporal change in the temperature distribution, it is possible to determine presence or absence of a gap between the concrete structure 61 and the slope 100 by measuring the temporal change in the temperature distribution along the longitudinal direction of the optical fiber 12.

The measurement method of the present embodiment may further include an optional step.

### (3) Correction Step

The measurement method of the present embodiment may further include a correction step.

In the correction step, strain measured in the measurement step can be corrected using temperature measured in the measurement step.

In the correction step, strain after being corrected can be calculated by, for example, the following equation (1).

$$( Strain after being corrected ( \% ) ) = ( Measured strain ( \% ) ) - ( Measured temperature ( ° C . ) ) \times ( Temperature coefficient ( \% / ° C . ) ) \qquad ( 1 )$$

Instead of the “Measured temperature” in the equation (1), a temperature change from a reference temperature may be used.

For example, the temperature coefficient can be previously calculated from the relationship between known temperatures and known amounts of strain, using the same optical fiber as that used for the measurement.

By performing the correction step, it is possible to correct a measured strain and a strain distribution by temperature, and to measure strain with a particularly good accuracy

### [3] Manufacturing Method for Measurement Devices

A manufacturing method for measurement devices according to the present embodiment will be described. According to the manufacturing method for measurement devices according to the present embodiment, the measurement device according to one embodiment of the present disclosure can be manufactured. Thus, description of some of the particulars described regarding the measurement device and the measurement method will be omitted.

### (1) Optical Fiber Arrangement Step and Material to Secure Arrangement Step

The manufacturing method for measurement devices according to the present embodiment can include an optical fiber arrangement step.

In the optical fiber arrangement step, the optical fiber arrangement part 111 having a planar shape can be formed by arranging the optical fiber 12 along the surface of the slope 100.

According to the manufacturing method for measurement devices according to the present embodiment, it is possible to manufacture a measurement device including the measurement part 11 including the optical fiber arrangement part 111 having a planar shape, the measurement part 11 including the optical fiber 12 arranged along the surface of the slope 100. Therefore, according to the manufacturing method for measurement devices of the present embodiment, it is possible to manufacture a measurement device capable of measuring one or more measurement values selected from strain, temperature, or vibration over a wide range of the entirety of the optical fiber arrangement part in which the optical fiber is arranged.

In the optical fiber arrangement step, for example, as shown in FIG. 1, the optical fiber 12 may be arranged in the optical fiber arrangement part 111 to have a plurality of deviated sections 120. In the optical fiber arrangement step, a plurality of optical fibers 12 may be arranged along the surface of the slope 100. Here, as described with reference to FIG. 2, if necessary, the plurality of optical fibers 12 may be arranged such that at least some of them intersect each other.

The optical fiber 12 may be subjected to the optical fiber arrangement step after being arranged in the protective material 41. That is, the measurement part 11 may further include a longitudinal protective material 41. In this case, the optical fiber 12 may be arranged along the longitudinal direction of the protective material 41, and a part of the surface of the optical fiber 12 may be covered with the protective material 41.

By providing the measurement part 11 with the protective material 41, arranging at least a part of the optical fiber 12 along the longitudinal direction of the protective material 41, and covering a part of the surface of the optical fiber 12 with the protective material 41, it is possible to prevent the optical fiber 12 from fracture and the like.

In the optical fiber arrangement step, the method for arranging and secure the optical fiber 12 on the slope 100 is not particularly limited. For example, the optical fiber 12 may be secured by the material 51 to secure the optical fiber, previously installed in the optical fiber arrangement part 111.

When arranging the material 51 to secure the optical fiber in the optical fiber arrangement part 111, the manufacturing method for measurement devices according to the present embodiment may include a material to secure arrangement step of arranging the material 51 to secure the optical fiber along the surface of the slope 100. In the material to secure arrangement step, the material 51 to secure the optical fiber may be arranged and secured along the surface of the slope 100.

### (2) Optical Fiber Position Recording Step

The manufacturing method for measurement devices according to the present embodiment may include an optical fiber position recording step.

The optical fiber position recording step can record the position of the optical fiber 12 in the optical fiber arrangement part 111. The position of the optical fiber 12 recorded in the optical fiber position recording step can be recorded and stored, for example, in the recorder 15 of the measurement device according to one embodiment of the present disclosure.

By providing the manufacturing method for measurement devices according to the present embodiment with the optical fiber position recording step to record the positional information of the optical fiber 12 on the slope 100, it is possible to identify the position, at which measurement values regarding the slope 100, such as strain and the like, are acquired, easily. Therefore, the state of the slope 100 can be evaluated particularly accurately.

### (3) Concrete Structure Arrangement Step

The manufacturing method for measurement devices according to the present embodiment may include a concrete structure arrangement step.

In the concrete structure arrangement step, the slope 100 and the optical fiber arrangement part 111 can be blown with mortar or concrete to be coated with mortar or concrete. When the blown mortar or concrete has cured, the concrete structure can be completed.

By performing the concrete structure arrangement step, it is possible to protect the optical fiber 12 and the slope 100, and to enhance the shape stability of the slope 100.

What is claimed is:

1. A measurement device, comprising:
a measurement part including an optical fiber arrangement part having a planar shape,
wherein the measurement part includes: an optical fiber arranged in the optical fiber arrangement part; and a longitudinal protective material, and
at least a part of the optical fiber is arranged along a longitudinal direction of the protective material, and a part of a surface of the optical fiber is covered with the protective material.

2. The measurement device according to claim 1,
wherein the optical fiber has a plurality of deviated sections in the optical fiber arrangement part.

3. The measurement device according to claim 1,
wherein the measurement part includes a plurality of optical fibers, each of which is the optical fiber, and
at least some of the plurality of optical fibers are arranged to intersect each other in the plane view.

4. The measurement device according to claim 1,
wherein the protective material includes a stranded wire obtained by twisting element wires composed of metal, and
the optical fiber is arranged in a helical groove of the stranded wire.

5. The measurement device according to claim 1,
wherein the measurement part includes a material to secure at least a part of the optical fiber in place in the optical fiber arrangement part.

6. The measurement device according to claim 5,
wherein at least a part of the material to secure the optical fiber has a grid shape in the plane view.

7. The measurement device according to claim 1,
wherein the measurement part further includes a scattered light measurement device connected to the optical fiber.

8. The measurement device according to claim 1,
wherein the optical fiber arrangement part is arranged along a surface of a slope, and
the measurement device further includes
a processor configured to calculate a measurement value including one or more selected from strain, temperature, or vibration of the slope from the measurement data obtained by the measurement part.

9. The measurement device according to claim 8,
wherein the measurement part performs measurements for a plurality of times at predetermined timings, and
the processor calculates temporal changes in the measurement values of the slope.

10. The measurement device according to claim 9, further comprising:
an alarm function configured to issue an alarm when a degree of the temporal change in the measurement value of the slope calculated by the processor exceeds a predetermined range.

11. The measurement device according to claim 8,
wherein the memory is configured to record positional information of the optical fiber in the optical fiber arrangement part on the slope, and
the processor is further configured to identify a position, at which the measurement value of the slope calculated by the processor is acquired, based on the positional information of the optical fiber stored in the memory.

12. The measurement device according to claim 8,
wherein the optical fiber has deviated sections arranged along the longitudinal direction of the optical fiber at certain intervals, and
the processor is further configured to identify positions of the deviated sections in measurement data measured by the measurement part, and identify the position, at which the measurement value on the slope calculated by the processor is acquired.

13. A measurement method, comprising:
measuring, by a measurement device, measurement data including one or more selected from strain, temperature, or vibration on the slope,
wherein the measurement device includes a measurement part including: an optical fiber arrangement part having a planar shape and arranged along a surface of the slope; and a scattered light measurement device,
the measurement part includes: an optical fiber arranged in the optical fiber arrangement part; and a longitudinal protective material, at least a part of the optical fiber being arranged along the longitudinal direction of the protective material, and a part of a surface of the optical fiber being covered with the protective material,
the optical fiber is connected to the scattered light measurement device, and
in the measurement process, the measurement data on the slope along the longitudinal direction of the optical fiber is measured by oscillating scattered light emitted into the optical fiber from the scattered light measurement device.

14. The measurement method according to claim 13,
wherein the slope and the optical fiber arrangement part are covered with a concrete structure,
in the measurement process, the measurement data along the longitudinal direction of the optical fiber is measured for a plurality of times at the predetermined intervals, using the optical fiber, and
the measurement method further comprises:
performing first determination of deformations in the concrete structure from temporal changes in the measurement data along the longitudinal direction of the optical fiber measured at the measurement.

15. The measurement method according to claim 13,
wherein the measurement part includes at least two optical fibers, each of which is the optical fiber, arranged in parallel in the optical fiber arrangement part,
the slope and the optical fiber arrangement part are covered with a concrete structure,
in the measurement process, strain along the longitudinal direction of the optical fiber is measured using at least two optical fibers arranged in parallel, and
the measurement method further comprises:
performing second determination that deformations have occurred in the concrete structure in a case where a difference between the strain values measured using the at least two optical fibers arranged in parallel is equal to or greater than a predetermined value.

16. The measurement method according to claim 13,
wherein the slope and the optical fiber arrangement part are covered with a concrete structure,
in the measurement process, vibration of the slope along the longitudinal direction of the optical fiber is measured, and
the measurement method further comprises:
performing third determination of a gap between the concrete structure and the slope from a distribution of the measured vibration along the longitudinal direction of the optical fiber.

17. The measurement method according to claim 13,
wherein the slope and the optical fiber arrangement part are covered with a concrete structure,
in the measurement process, a temperature of the slope along the longitudinal direction of the optical fiber is measured for a plurality of times at predetermined time intervals, and
the measurement method further comprises:
performing fourth determination of a gap between the concrete structure and the slope from temporal changes in the measured temperature along the longitudinal direction of the optical fiber.

18. A manufacturing method for measurement devices, comprising:
arranging an optical fiber along the surface of the slope to form an optical fiber arrangement part having a planar shape; and
recording the position of the optical fiber in the optical fiber arrangement part,
wherein the optical fiber arrangement part further includes a longitudinal protective material, and
at least a part of the optical fiber is arranged along a longitudinal direction of the protective material, and a part of a surface of the optical fiber is covered with the protective material.
